(19) United States
(12) Patent Application Publication
(10) Pub. No.: US 2005/0238345 A1
(43) Pub. Date: Oct. 27, 2005

(54) Twin drive camera shielding device

(76) Inventor: Chi-Sheng Hsieh, Chupei City (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 11/111,922

(22) Filed: Apr. 22, 2005

(30) Foreign Application Priority Data
Apr. 23, 2004 (TW) 93206268

(51) Int. Cl. G03B 17/00

(52) U.S. Cl. 396/427

(57) ABSTRACT

A twin drive camera shielding may adjust the photographic angle of a camera and may uncover, cover, and disguise the camera through a driving power of a driver for achievement of disguising the device, comprising an outer casing and a shielding device, in which a holder and a shielding body are accommodated in the shielding device, the shielding body has a shielding faceplate, a driver and a camera are accommodated inside the body, and the spindle of driver is fixed onto a fixed holder, so when the driver is electrified, the driver runs because of its fixed spindle; the driver and the camera are located behind the shielding faceplate, so when the driver is powered, the shielding body opposite to the holder does an uncovering or covering action to make the lens of camera emerge or submerge, and when the lens of camera emerge, the photographic angle may be adjusted.

### BACKGROUND OF THE INVENTION

1. Field of the Invention

This invention relates to a twin drive camera shielding device and particularly to a device that may adjust the photographic angle of a camera and raise and shield the camera through the same driving power of a driver for achievement of hiding the device.

2. Description of the Prior Art

Conventionally, among electrically driven camera devices in international markets and from Taiwan Patent Search, generally a fixed camera and a power-driven camera were those used in watch camera industry from year 1995 to year 2003, the report given from international monitoring equipment exhibitions in USA, Japan, and UK.

The lens of the current fixed camera, such as the Laid-Open No. 425050, “Angle Adjustment Mechanism for Camera Lens”, is pre-adjusted for an angle, and a manual re-adjustment is required afterwards.

Speed Dome Camera is currently a familiar imported power-driven camera, and about tens of brands, such as Pelco and Sensormatic from USA and Panasonic and To a from Japan, are imported. All brands of power-driven cameras have the same features, such as “Watch Camera” disclosed in Taiwan Patent Nos. 200479 and 200079, U.S. patent No. U.S. Pat. No. 6,604,868 B, and Taiwan Patent Laid-Open No. 557067; that is, all the cameras are driven by a motor working in a horizontal direction and a motor working in a vertical direction. The camera lens are generally provided in a transparent, visible light spherical mask; if a camera is made in disguise, a visible light spherical mask that is colored will be used, but it usually interferes the chromaticity of an image. Thus, The transparent, achromatic spherical mask is familiar and provided for protection only. Camera lens of European standard generally emerge outside that is easily found for warning effect. However, Americans mostly think that it will encroach on their right of privacy.

Regardless of the problems above, the power-driven effect is to drive the camera to run for getting more and wider photographic angle. The function of disguising or emerging the drive camera has not been found yet.

A motor generally uncovers the shielding cover provided before the camera lens of the camera. In recent years, the motor driving the cover is provided in popular digital still cameras or camcorder, but it is provided to enable or disable the shielding cover only without a function of rotating the lens to adjust the photographic angle.

Seen from the description above, there is no such a product of which the function is provided to uncover the cover and meanwhile rotate the camera lens; especially, two motors may be required to do two actions, “cover enable and cover disable” and “photographic angle adjustment”.

Further, seen from an art disclosed in Taiwan Patent No. 202924, titled “A Motor Structure for Car Backing”, a linking gear 31 on a drive cover plate of a drive gear 21 of a servo motor shaft is provided; the servo motor is secured in a trunk, while a camera is fixed onto the chassis of cover plate; thus, the structures must be designed into an organic whole; if a customer has a preconceived idea on the trunk, the customer must have another choice and cannot replace the trunk only, and thereby all components of the patented product are assembled into unity for market commercialization; namely, after the finished product is made in a factory, the form of an outer casing is not easily replaced with different ones so that it may not satisfy customers on different demands, thereby the product being unmarketable.

Consequently, in consideration of the problems caused by the conventional photographic device, this inventor further improves it and finally successfully develops the twin drive camera shielding device according to this invention after having made extraordinarily painstaking efforts to study diligently with a quiet mind for many years.

### SUMMARY OF THE INVENTION

It is a main object of this invention to provide a twin drive camera shielding device that may adjust the photographic angle of a camera and raise and shield the camera through the driving power of a driver and further may adjust a surveillant angle and range at any time upon users' demands and hide the camera.

It is a further object of this invention to provide a twin drive camera shielding device of which a casing may be replaceable upon the demands of markets and customers, thereby each model of product being formed, the cost being decreased, and the demands of different customers being met.

In order to achieve the object mentioned above, this invention comprises:
a holder that may be fixed onto another object to mainly support a shielding device relatively rotating and that is provided with a position for connection to a driver spindle located in the shielding device to rotate, in which only a motor of the driver rotates but the spindle and the holder do not;
a shielding device relatively rotating and comprising at least a camera, a shielding faceplate, and a driver.

### BRIEF DESCRIPTION OF THE DRAWINGS

The drawings disclose an illustrative embodiment of the present invention which serves to exemplify the various advantages and objects hereof, and are as follows:

FIG. 1 is one of the 3D views of the appearance of an embodiment according to this invention.

FIG. 2 is the other one of the 3D views of the appearance of the embodiment according to this invention.

FIG. 3 is a main exploded structural view of FIG. 2.

FIG. 4 is a 3D structural view of a shielding device according to this invention.

FIGS. 5 and 5A are structural views showing a shielding body provided in the shielding device according to this invention.

FIG. 6 is a view showing a main structure of a driver according to this invention.

FIGS. 7 and 7A are views showing the relationship between a holder and the driver.

### DETAILED DESCRIPTION OF THE PREFERRED EMBODIMENT

In order to let you further know the features and technical means of this invention, refer to the following detailed description according to this invention accompanied with drawings; however, the accompanied drawings are provided for reference and illustration only and are not limited to this invention.

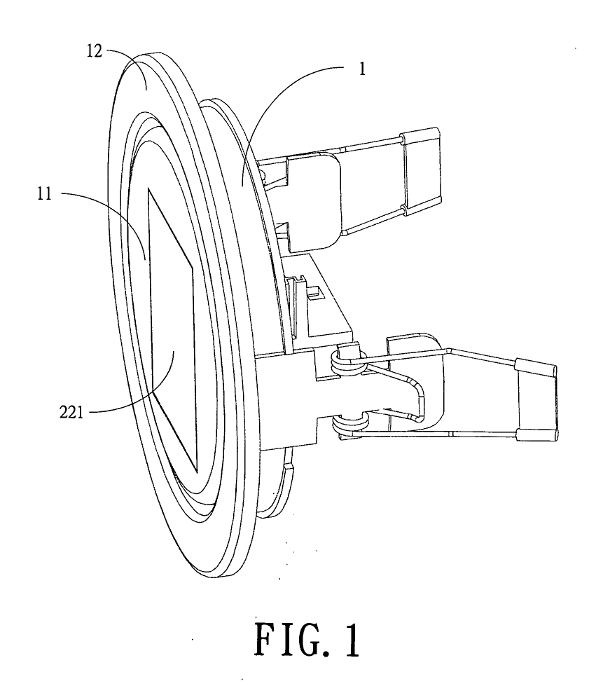

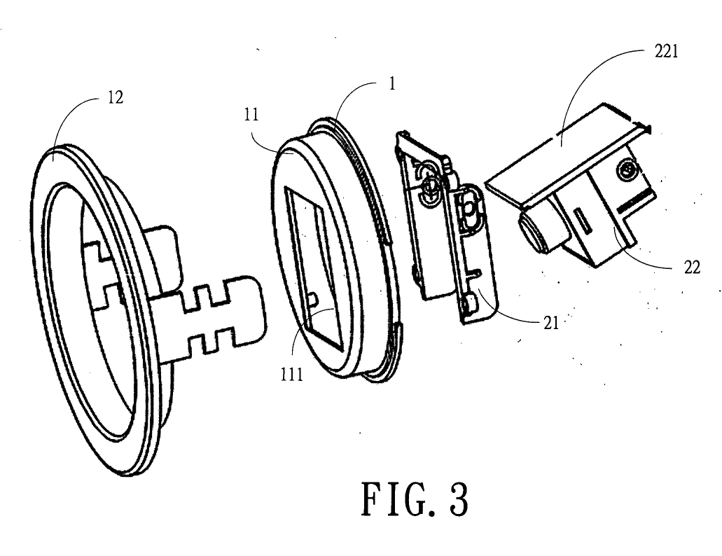

Referring now to FIGS. 1 and 3, views of the appearance of a device according to this invention in an embodiment, it is an object to provide a function to disguise the device.

Seen from the appearance, an outer casing 1, a faceplate 11 of the outer casing 1, a decorative body 12 of the outer casing 1, a faceplate 221 of a shielding body, in which the decorative body 12 of the outer casing 1 is provided to decorate the outer casing 1 and assist the outer casing to be located, as shown in FIG. 1, embedded inside. The faceplate 11 of outer casing 1 and the faceplate 221 of shielding body are set horizontally, being looked from a distant place as if it is a large flat panel.

Further, the outer casing 1 may be provided with an extra floodlight source to function as an illuminator and keep others under the delusion for achievement of the function of disguise.

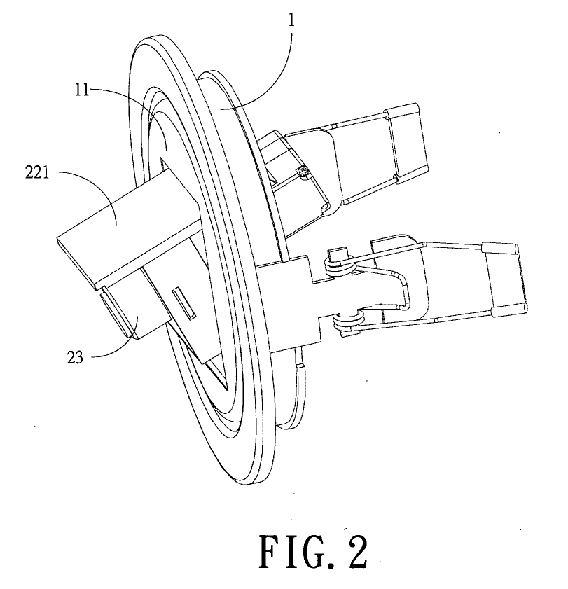

Referring now to FIG. 2, the other view of the appearance of the device according to this invention in the embodiment, being looked in FIG. 1 by appearance as if it is a large flat panel, the faceplate 11 of outer casing 1 and the faceplate 221 of shielding body being not set horizontally, in which compared with the faceplate 11 of outer casing 1, the faceplate 221 of shielding body is uncovered in a certain angle. A camera 23 may also be seen under the faceplate 221 of shielding body. FIG. 3 is a view showing an main exploded structure of this device.

Referring now to FIG. 3, there are four main fittings, the decorative body 12 of the outer casing 1, the faceplate 11 of outer casing 1, the holder 21, and the shielding body 22.

The decorative body 12 of the outer casing 1 may be provided for different forms and flexibly changed into different models of products upon the demands of different customers. A square cavity 111 of the faceplate 11 of outer casing 1 is provided to allow the square faceplate 221 of shielding body 22, and the size of the square cavity 111 of faceplate 11 must match with the square faceplate 221 of shielding body 22 for beauty and disguise. The holder 21 and the shielding body 22 are named a shielding device 2.

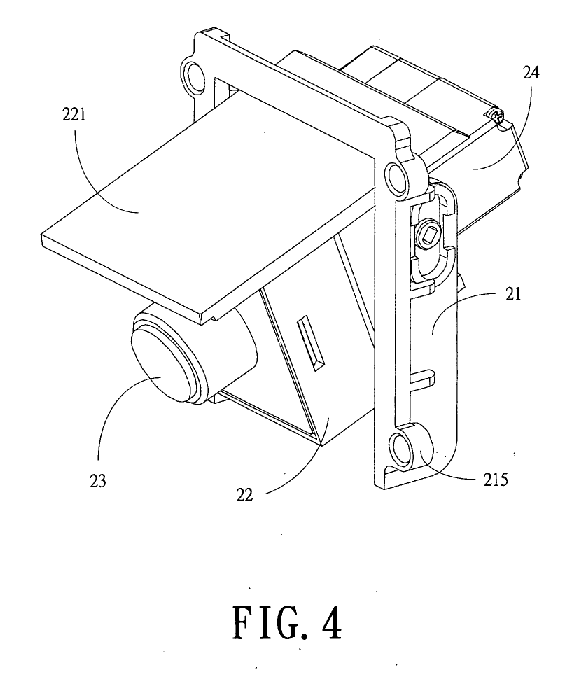

FIGS. 1 and 4 are 3D structural views of the shielding device according to this invention. The shielding device is made up with two essential parts, the holder 21 and the shielding body 22.

Four holes 215 are respectively provided around four corners of the holder so as to be locked onto different outer casings 1, and thereby the casings 1 are changed into different ones and different products are formed upon the demands of different customers. The shielding body 22 is provided with a faceplate 221, inside which a camera 23 and a driver 24 are allowed.

The camera 23 and the driver 24 that are accommodated in the shielding body 22 are described in detail as follows.

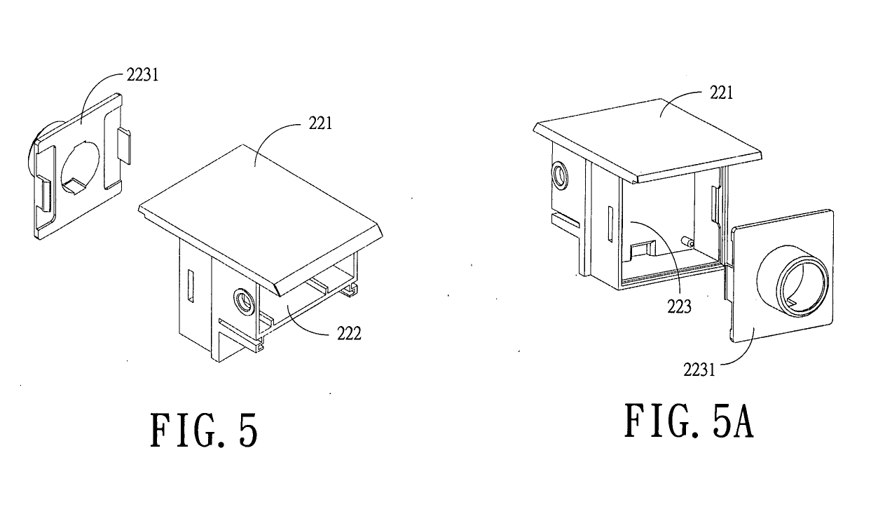

FIGS. 4, 5, and 5A are structural views showing the shielding body 22 provided in the shielding device 2 according to this invention.

The shielding body 22 comprises the faceplate 221 of shielding body 22, a container 222 accommodating the driver 24 and a container 223 accommodating the camera 23, and a protective cover for the lens of camera 23. From the description above, the shielding body 22 comprises the camera 23 and the driver 24.

Next, description of covering and uncovering the shielding device 2 is made below.

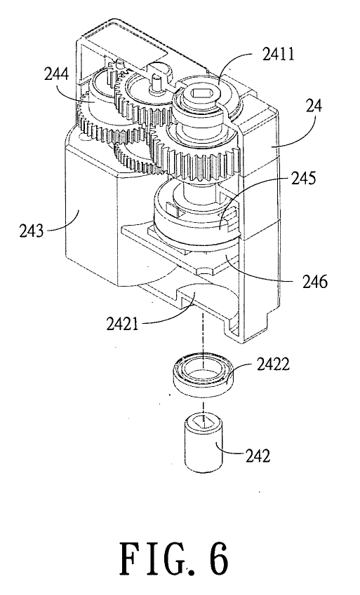

FIGS. 3 and 6 are views showing a main structure of a driver 24 according to this invention.

The driver 24 comprises a concave spindle 241, a symmetrical axis 242, a DC motor 243, a potentiometer 245, and an operational circuit 246.

Description of only covering and uncovering the shielding device 2 is made that is directly coordinate with the concave spindle 241, the symmetrical axis 242, and the DC motor 243 but the potentiometer 245 and the operational circuit 246 that is disclosed in Taiwan Patent No. 200479, titled “A Servo Control Device Driving A Camera”, this inventor applied for and that will not be described in detail.

The concave spindle 241 is also a revolving spindle driven by the DC motor 243, and when the DC motor 243 is electrified, the concave spindle 241 revolves, and when the DC motor 243 is electrified with a reverse current, the concave spindle 241 revolves in a reverse direction. Description of the function of a round groove of the bottom of the symmetrical axis 242, a bearing 2422, and the driver 24 is made below.

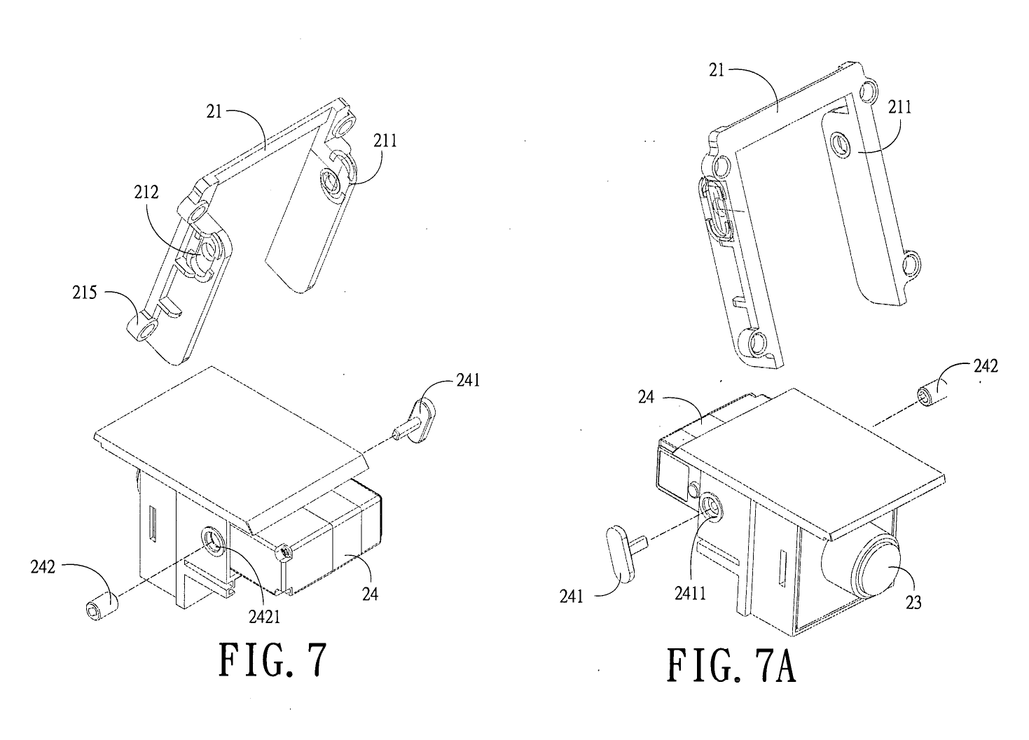

FIGS. 3, 7, and 7A shows the relationship between the holder 21 and the driver 24, namely, the description of covering and uncovering the shielding device 2.

After the container 222 is placed in the driver 24, a convex bolt 241 is used to put through a hole 211 of the holder 21 and then the concave spindle 241 of the driver 24 is inserted.

In order to make the driver 24 run smoothly, such a symmetrical axis 242 is again used to pass through a hole 212 of the holder 21 and then inserted into the round groove 2421 of the bottom of driver 24 as shown in FIG. 6, in which the round groove 2421 is secured with the bearing 2422 to make the symmetrical axis 242 glide smoothly. The spindle 2411 and the symmetrical axis 242 are joined together to mainly keep a supporting point between the left and right sides of the driver 24 running balanced, thereby its running being smooth.

The holder 21 has the hole 211 securely connected to the concave spindle 241 of the driver 24, and after the driver 24 is electrified, the spindle 2411 revolves; however, the holes 211 of spindle 241 and holder 21 are connected and secured, so a fixed part and a revolved part that are joined are the relationship between the driver 24 and the holder 21.

In other words, after the driver 24 is powered, if the driver 24 is kept fixed, then the holder 21 will run; on the contrary, after the driver 24 is powered, if the holder 21 is kept fixed, then the driver 24 will run.

This device makes the holder 21 fixed, and thereby the driver 24 runs; once the driver 24 runs, the driver 24 accommodated in the shielding body 22 drive the shielding body 22 to run and the running shielding body 22 makes the shielding body 22 do the covering and uncovering actions.

When the driver 24 is supplied with a positive or negative power, the shielding body 22 may do uncovering or covering action.

A direction of image snapped by the lens of camera 23 in the shielding body 22 is horizontal to the face of faceplate 221 of the shielding body 22 so that when being uncovered to move, the shielding faceplate 221 may emerge in the mean time and, move the camera 23 for a photographic angle, and the face of faceplate 221 of the shielding body 22 may be fixed to the surface of a mouse of the outer casing 1 symmetrically and horizontally for achievement of the disguise effect when the shielding body 22 does the covering action.

From the above-mentioned embodiment, it is apparent that this invention may be applied to the following products.

For a first application, this invention may be applied to a car for a car driver to watch a status when backing the car. The shielding device 2 is located in the backside of the car, such as inside of a turbulent flow plate, a rear tail, and a bumper. When the driver drives into a reverse gear, a car backing signal source drives the DC motor 243 to be electrified, and thereby the shielding faceplate 221 is uncovered to move the camera 23 for the photographic angle so that the driver may watch the surrounding behind the car, such as a child, a gutter, or other obstacles, on a monitor installed in a cockpit. Further, After the car backing is finished, a “Finish” car backing signal source drives the DC motor 243 to be electrified with a negative power and then the shielding faceplate 221 is covered for protection to the camera. The shielding device 2 may be available to different bodyworks and may be replaced.

As shown in FIG. 1, the faceplate 11 of outer casing 1 (bodyworks) and the faceplate 221 of shielding body 22 are set horizontally, being looked from a distant place as if it is a large flat panel. If the backsides of all brands of cars, such as the surface of the shielding faceplate 221, are printed, painted, or floated with the logos of the cars, after the shielding faceplate 221 turns from the uncovering state (as shown in FIG. 2) to the covering state (as shown in FIG. 1), the logo will appear again and will not affect the logo for beauty and denotation.

For a second application, this invention may be available to monitoring for guarding against thieves. As described above, when the shielding device 2 is uncovered, not only the camera may emerge to monitor by way of photography, but also the photographic angle of the camera 23 may be adjusted; when the shielding device 2 cover does the covering action, the disguise effect may be achieved.

Further, the outer casing 1 according to this invention may be provided with an extra floodlight source to function as an illuminator and keep others under the delusion for achievement of the function of disguise.

However, in the description mentioned above, only the preferred embodiments according to this invention are provided without limit to this invention and the characteristics of this invention; all those skilled in the art without exception should include the equivalent changes and modifications as falling within the true scope and spirit of the present invention.

From the detailed description above, with the structure according to this invention, the camera may be indeed adjusted for the photographic angle and may uncover or disguise the shielding device, and the shielding device is easily replaced and further may adjust a surveillant angle and range at any time upon users' demands. No related products are found in the industry, so this invention completely meets the requirements of application for the new type patent. Thus, we apply following articles 97 and 98 of the patent law; we earnestly request you to examine it for details and to approve the patent as soon as possible for protection of the inventor's rights and interests.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A twin drive camera shielding that may adjust the photographic angle of a camera and may uncover and cover the camera through a driving power of a driver for achievement of disguising the device, comprising:
an outer casing mainly provided for installation and disguise of the shielding device; and
the shielding device comprising at least a fixed holder and a shielding body rotatable, in which the shielding body comprises at least a shielding faceplate, a container, a camera, and a driver, in which the container may accommodate the camera and the driver.

2. The twin drive camera shielding according to claim 1, wherein the outer casing is made up with a faceplate and a decorative body, in which the faceplate of outer casing is bored with a cavity of which a shape and a size should match with those of the shielding faceplate for achievement of disguise, and the decorative body of outer casing assists to decorate the outer casing and a structure of the side of decorative body may be properly provided for installation of the entire device, and the outer casing may be provided with an extra floodlight source to function as an illuminator and keep others under the delusion for achievement of the function of disguise.

3. The twin drive camera shielding according to claim 1, wherein the holder of the shielding device may be fixed onto the outer casing and may be one of the structures of the outer casing and it is used to mainly support the shielding body rotatable and make the shielding body balanced when the shielding body does an uncovering or covering action.

4. The twin drive camera shielding according to claim 1, wherein a direction of image snapped by the lens of camera in the shielding body is horizontal to the face of faceplate of the shielding body so that a moving angle of the shielding faceplate uncovered is consistent with the angle of image snapped by the lens of camera for achievement of uncovering and covering the camera and adjusting the photographic angle of the lens of camera.

5. The twin drive camera shielding according to claim 1, wherein the driver of the shielding device comprises at least a driving motor that, when electrified, may drive the driver to do an uncovering action in a certain angle or a covering action, in which after the motor is electrified, a driving force may be produced by a spindle of the driving motor or the motor.

6. The twin drive camera shielding according to claim 1, wherein two opposite sides of the driver has a driving spindle and a groove accommodating a symmetrical axis, and when the spindle of driver and the accommodated symmetrical axis are fixed to the holder, if the holder is fixed, the driver may be run; on the contrary, if the driver is fixed, the holder may be run, which may be set upon the requirements of a real product.

7. The twin drive camera shielding according to claim 1, wherein the faceplates of the outer casing and shielding body may be printed, painted, or floated with patterns or trademarks relates to all kinds of products, and when the device enables the shielding function, the large faceplate set horizontally may achieve effect(s) of disguise, advertisement, or both of the two.
